(19) United States
(12) Patent Application Publication
(10) Pub. No.: US 2019/0299987 A1
(43) Pub. Date: Oct. 3, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Akihiro Toda, Wako-shi (JP); Yuki Motegi, Tokyo (JP); Chie Sugihara, Tokyo (JP)

(21) Appl. No.: 16/288,131

(22) Filed: Feb. 28, 2019

(30) Foreign Application Priority Data
Apr. 2, 2018 (JP) 2018-070888

(51) Int. Cl. B60W 30/12; G06K 9/00; G05D 1/02

(52) U.S. Cl. CPC B60W 30/12; G06K 9/00798; G05D 2201/0213; B60W 2550/22; G05D 1/0214

(57) ABSTRACT

A vehicle control device includes a recognizer configured to recognize a two-wheeled vehicle dedicated lane that is present adjacent to a subject lane on which a subject vehicle is present, and a driving controller configured to control at least steering of the subject vehicle and cause the subject vehicle to move far away from the two-wheeled vehicle dedicated lane in the subject lane in comparison with a case where the two-wheeled vehicle dedicated lane is not recognized by the recognizer, in a case where the two-wheeled vehicle dedicated lane is recognized by the recognizer.

### CROSS-REFERENCE TO RELATED APPLICATION

This application is based upon and claims the benefit of priority from Japanese Patent Application No. 2018-070888, filed Apr. 2, 2018, the entire content of which is incorporated herein by reference.

### BACKGROUND

### Field of the Invention

The present invention relates to a vehicle control device, a vehicle control method, and a storage medium.

### Description of Related Art

In recent years, research on automatically controlling driving of a vehicle (hereinafter, referred to as automated driving) has been in progress. Meanwhile, a technique for performing control to avoid collision earlier for a higher bicycle speed by predicting a traveling direction of a bicycle on which a rider is riding is known (refer to, for example, Japanese Unexamined Patent Application, First Publication No. 2015-014948).

### SUMMARY

However, in the related art, in a case where a two-wheeled vehicle such as a bicycle is traveling in a dedicated lane, there is a case where a subject vehicle becomes too close to the two-wheeled traveling in the other lane.

An aspect of the present invention has been made in consideration of such circumstances, and an object of the aspect of the present invention is to provide a vehicle control device, a vehicle control method, and a storage medium capable of performing automated driving sufficiently far away from a two-wheeled vehicle of another lane. A vehicle control device, a vehicle control method, and a storage medium according to the present invention adopt the following constitutions.

According to one aspect (1) of the present invention, a vehicle control device according to an aspect of the present invention includes a recognizer configured to recognize a two-wheeled vehicle dedicated lane that is present adjacent to a subject lane on which a subject vehicle is present, and a driving controller configured to control at least steering of the subject vehicle and cause the subject vehicle to move far away from the two-wheeled vehicle dedicated lane in the subject lane in comparison with a case where the two-wheeled vehicle dedicated lane is not recognized by the recognizer, in a case where the two-wheeled vehicle dedicated lane is recognized by the recognizer. According to an aspect of (2), in the vehicle control device according to the aspect of (1), the driving controller determines a degree to which the subject vehicle is caused to move away from the two-wheeled vehicle dedicated lane in the subject lane, on the basis of a width of the two-wheeled vehicle dedicated lane.

According to an aspect of (3), in the vehicle control device according to the aspect of (1) or (2), the driving controller causes the subject vehicle to move far away from the two-wheeled vehicle dedicated lane in the subject lane as a width of the two-wheeled vehicle dedicated lane becomes narrower.

According to an aspect of (4), in the vehicle control device according to any one aspect of (1) to (3), in a case where a width of the two-wheeled vehicle dedicated lane is equal to or less than a threshold value, the driving controller causes the subject vehicle to move far away from the two-wheeled vehicle dedicated lane in the subject lane in comparison with a case where the width of the two-wheeled vehicle dedicated lane is greater than the threshold value.

According to an aspect of (5), in the vehicle control device according to any one aspect of (1) to (4), the recognizer further recognizes a start point of the two-wheeled vehicle dedicated lane, and in a case where the start point recognized by the recognizer is present in front of the subject vehicle, the driving controller causes the subject vehicle to move far away from the two-wheeled vehicle dedicated lane in the subject lane in comparison with a case where the subject vehicle is present at a position behind the start point, at the start point.

According to an aspect of (6), in the vehicle control device according to any one aspect of (1) to (5), the recognizer further recognizes a structure separation point where a structure extending along a road is broken, which is a structure that represents a boundary of the road including the subject lane and the two-wheeled vehicle dedicated lane, and in a case where the structure separation point recognized by the recognizer is present in front of the subject vehicle, the driving controller causes the subject vehicle to move far away from the two-wheeled vehicle dedicated lane in the subject lane in comparison with a case where the structure separation point is not present in front of the subject vehicle, at the structure separation point.

According to an aspect of (7), in the vehicle control device according to any one aspect of (1) to (6), the recognizer further recognizes a structure that is present between the subject lane and the two-wheeled vehicle dedicated lane, and in a case where the structure that is present between the subject lane and the two-wheeled vehicle dedicated lane is recognized by the recognizer, the driving controller causes the subject vehicle to be not away from the two-wheeled vehicle dedicated lane in the subject lane in comparison with a case where the structure that is present between the subject lane and the two-wheeled vehicle dedicated lane is not recognized by the recognizer.

According to an aspect of (8), in the vehicle control device according to any one aspect of (1) to (7), in the case where the two-wheeled vehicle dedicated lane is recognized by the recognizer, the driving controller further controls a speed of the subject vehicle so that the speed of the subject vehicle is reduced in comparison with the case where the two-wheeled vehicle dedicated lane is not recognized by the recognizer.

According to an aspect of (9), in the vehicle control device according to the aspect of (8), the driving controller determines a degree of the reduction in the speed of the subject vehicle on the basis of a width of the two-wheeled vehicle dedicated lane.

According to an aspect of (10), in the vehicle control device according to the aspect of (8) or (9), the driving controller causes the speed of the subject vehicle to be less as a width of the two-wheeled vehicle dedicated lane becomes narrower.

According to an aspect of (11), in the vehicle control device according to any one aspect of (8) to (10), in a case where a width of the two-wheeled vehicle dedicated lane is equal to or less than a threshold value, the driving controller reduces the speed of the subject vehicle in comparison with a case where the width of the two-wheeled vehicle dedicated lane is greater than the threshold value.

According to an aspect of (12), in the vehicle control device according to any one aspect of (8) to (11), the recognizer further recognizes a start point of the two-wheeled vehicle dedicated lane, and in a case where the start point recognized by the recognizer is present in front of the subject vehicle, the driving controller reduces the speed of the subject vehicle in comparison with a case where the subject vehicle is present at a position behind the start point, at the start point.

According to an aspect of (13), in the vehicle control device according to any one aspect of (8) to (12), the recognizer further recognizes a structure separation point where a structure extending along a road is broken, which is a structure that represents a boundary of the road including the subject lane and the two-wheeled vehicle dedicated lane, and in a case where the structure separation point recognized by the recognizer is present in front of the subject vehicle, the driving controller reduces the speed of the subject vehicle in comparison with a case where the structure separation point is not present in front of the subject vehicle, at the structure separation point.

According to an aspect of (14), in the vehicle control device according to any one aspect of (8) to (13), the recognizer further recognizes a structure that is present between the subject lane and the two-wheeled vehicle dedicated lane, and in a case where the structure that is present between the subject lane and the two-wheeled vehicle dedicated lane is recognized by the recognizer, the driving controller does not reduce the speed of the subject vehicle in comparison with a case where the structure that is present between the subject lane and the two-wheeled vehicle dedicated lane is not recognized by the recognizer.

According to another aspect (15) of the present invention, a vehicle control method according to another aspect of the present invention causes an in-vehicle computer to recognize a two-wheeled vehicle dedicated lane that is present adjacent to a subject lane on which a subject vehicle is present, and control at least steering of the subject vehicle to cause the subject vehicle to move far away from the two-wheeled vehicle dedicated lane in the subject lane in comparison with a case where the two-wheeled vehicle dedicated lane is not recognized, in a case where the two-wheeled vehicle dedicated lane is recognized.

According to another aspect (16) of the present invention, a computer-readable non-transitory storage medium according to another aspect of the present invention stores a program that causes an in-vehicle computer to execute a process of recognizing a two-wheeled vehicle dedicated lane that is present adjacent to a subject lane on which a subject vehicle is present, and a process of controlling at least steering of the subject vehicle to cause the subject vehicle to move far away from the two-wheeled vehicle dedicated lane in the subject lane in comparison with a case where the two-wheeled vehicle dedicated lane is not recognized, in a case where the two-wheeled vehicle dedicated lane is recognized.

According to any one aspect of (1) to (16), it is possible to perform automated driving sufficiently far away from a two-wheeled vehicle of another lane.

### BRIEF DESCRIPTION OF THE DRAWINGS

FIG. 1 is a constitution diagram of a vehicle system using a vehicle control device according to a first embodiment.

FIG. 2 is a functional constitution diagram of a first controller and a second controller.

FIG. 3 is a flowchart showing an example of a flow of a series of processes by an automated driving control device according to the first embodiment.

FIG. 4 is a diagram showing an example of a scene in which a subject vehicle is automatically driven in a case where a two-wheeled vehicle dedicated lane is adjacent to a subject lane.

FIG. 5 is a diagram showing an example of offset amount determination information.

FIG. 6 is a diagram showing an example of an offset distance determined according to a width of the two-wheeled vehicle dedicated lane.

FIG. 7 is a diagram showing another example of the offset amount determination information.

FIG. 8 is a diagram showing another example of the offset distance determined according to the width of the two-wheeled vehicle dedicated lane.

FIG. 9 is a diagram showing an example of a scene in which a start point of the two-wheeled vehicle dedicated lane is present.

FIG. 10 is a diagram showing an example of a scene in which a point where a road boundary structure is broken is present.

FIG. 11 is a diagram showing an example of a scene in which a lane separation structure is present.

FIG. 12 is a diagram showing an example of speed determination information.

FIG. 13 is a diagram showing another example of the speed determination information.

FIG. 14 is a diagram showing an example of a hardware constitution of the automated driving control device according to an embodiment.

### DESCRIPTION OF EMBODIMENTS

Hereinafter, embodiments of a vehicle control device, a vehicle control method, and a storage medium of the present invention will be described with reference to the drawings. A case where left-side driving is applied to the present invention will be described below, but in a case where right-side driving is applied to the present invention, it is only necessary to reverse left and right.

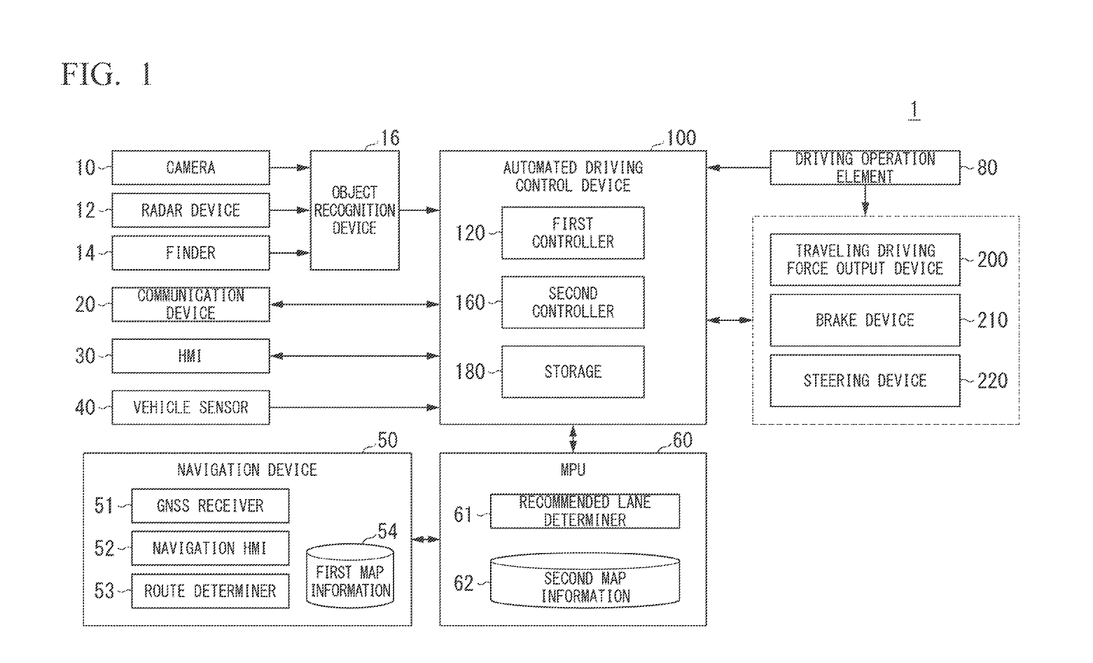

### First Embodiment

[Overall constitution] FIG. 1 is a constitution diagram of a vehicle system 1 using the vehicle control device according to a first embodiment. A vehicle (hereinafter, referred to as a subject vehicle M) in which the vehicle system 1 is mounted is, for example, a vehicle such as a two-wheeled vehicle, a three-wheeled vehicle, or a four-wheeled vehicle, and a driving source of the vehicle includes an internal combustion engine such as a diesel engine or a gasoline engine, an electric motor, or a combination thereof. The electric motor operates using electric power generated by a generator connected to the internal combustion engine, or discharge power of a secondary battery or a fuel cell.

For example, the vehicle system 1 includes a camera 10, a radar device 12, a finder 14, an object recognition device 16, a communication device 20, a human machine interface (HMI) 30, a vehicle sensor 40, a navigation device 50, a map-positioning unit (MPU) 60, a driving operation element 80, an automated driving control device 100, a traveling driving force output device 200, a brake device 210, and a steering device 220. Such devices and instruments are connected to each other by a multiplex communication line such as a controller area network (CAN) communication line, a serial communication line, a wireless communication network, or the like. The constitution shown in FIG. 1 is merely an example, and a part of the constitution may be omitted or other constitutions may be further added.

For example, the camera 10 is a digital camera using a solid imaging element such as a charge-coupled device (CCD) or a complementary metal-oxide-semiconductor (CMOS). The camera 10 is attached to an arbitrary place on the subject vehicle M. In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. The radar device 12 is attached to an arbitrary place on the subject vehicle M. The radar device 12 may detect the position and the speed of the object by a frequency-modulated continuous-wave (FM-CW) method.

The finder 14 is a light detection and ranging (LIDAR) system. The finder 14 irradiates light around the subject vehicle M and measures scattered light. The finder 14 detects the distance to the object on the basis of a time from light emission to light reception. For example, the irradiated light is laser light of a pulse shape. The finder 14 is attached to an arbitrary place on the subject vehicle M.

The object recognition device 16 performs a sensor fusion process on a detection result of some or all of the camera 10, the radar device 12, and the finder 14 to recognize a position, a type, a speed, and the like of the object. The object recognition device 16 outputs a recognition result to the automated driving control device 100. The object recognition device 16 may output the detection result of the camera 10, the radar device 12, and the finder 14 as they are to the automated driving control device 100. The object recognition device 16 may be omitted from the vehicle system 1.

For example, the communication device 20 communicates with another vehicle near the subject vehicle M using a cellular network, a Wi-Fi network, Bluetooth (registered trademark), dedicated short-range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, and the like.

The vehicle sensor 40 includes a vehicle speed sensor that detects a speed of the subject vehicle M, an acceleration sensor that detects acceleration, a yaw rate sensor that detects an angular velocity around a vertical axis, a direction sensor that detects a direction of the subject vehicle M, and the like.

For example, the navigation device 50 includes a global navigation satellite system (GNSS) receiver 51, a navigation HMI 52, and a route determiner 53. The navigation device 50 holds first map information 54 in a storage device such as a hard disk drive (HDD) or a flash memory.

The GNSS receiver 51 specifies the position of the subject vehicle M on the basis of a signal received from a GNSS satellite. The position of the subject vehicle M may be specified or supplemented by an inertial navigation system (INS) using an output of the vehicle sensor 40.

The navigation HMI 52 includes a display device, a speaker, a touch panel, a key, and the like. A part or all of the navigation HMI 52 may be shared with the above-described HMI 30.

For example, the route determiner 53 determines a route (hereinafter referred to as a route on a map) from the position of the subject vehicle M specified by the GNSS receiver 51 (or an input arbitrary position) to a destination input by the occupant using the navigation HMI 52 by referring to the first map information 54. For example, the first map information 54 is information in which a road shape is expressed by a link indicating a road and nodes connected by the link. The first map information 54 may include a curvature of the road, point of interest (POI) information, or the like. The route on the map is output to the MPU 60.

The navigation device 50 may perform route guidance using the navigation HMI 52 on the basis of the route on the map. For example, the navigation device 50 may be realized by a function of a terminal device such as a smartphone or a tablet terminal possessed by the user. The navigation device 50 may transmit a current position and a destination to a navigation server through the communication device 20 and acquire the same route as the route on the map from the navigation server.

For example, the MPU 60 includes a recommended lane determiner 61 and holds second map information 62 in the storage device such as an HDD or a flash memory. The recommended lane determiner 61 divides the route on the map provided from the navigation device 50 into a plurality of blocks (for example, divides the route into intervals of 100 [m] in a vehicle traveling direction), and determines a recommended lane for each block by referring to the second map information 62. The recommended lane determiner 61 determines the number of a lane from the left that the vehicle travels in. In a case where there is a branching position on the route on the map, the recommended lane determiner 61 determines the recommended lane so that the subject vehicle M is able to travel on a reasonable travel route for progressing to a branch destination.

The second map information 62 is map information with higher accuracy than the first map information 54. For example, the second map information 62 may include information on the center of the lane, information on the boundary of the lane, information on the type of the lane, and the like. The second map information 62 may include road information, traffic regulation information, address information (an address and a postal code), facility information, telephone number information, and the like. The second map information 62 may be updated at any time by the communication device 20 communicating with another device.

The driving operation element 80 includes, for example, an acceleration pedal, a brake pedal, a shift lever, a steering wheel, a modified steering wheel, a joystick, and other operation elements. A sensor that detects an operation amount or presence or absence of an operation is attached to the driving operation element 80, and a detection result of the sensor is output to a part or all of the automated driving control device 100, or the traveling driving force output device 200, the brake device 210, and the steering device 220.

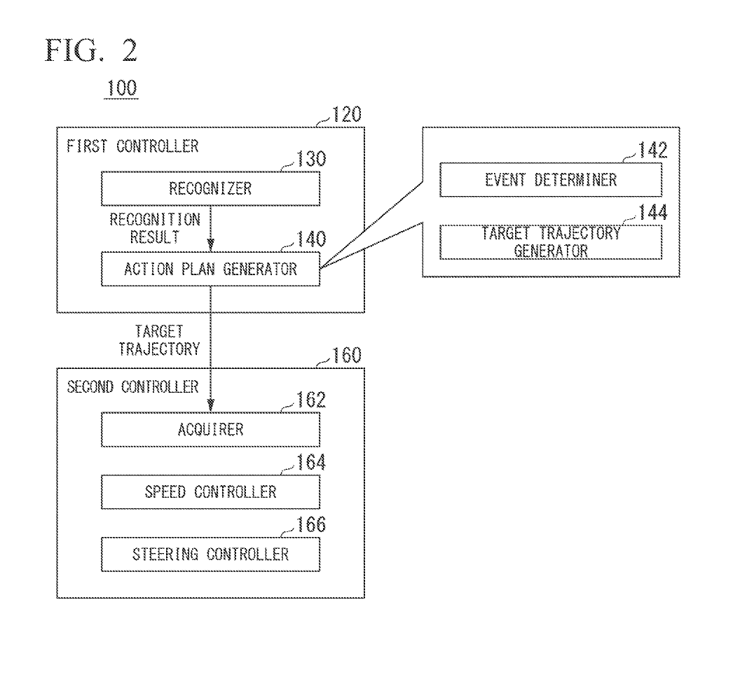

For example, the automated driving control device 100 includes a first controller 120, a second controller 160, and a storage 180. For example, the first controller 120 and the second controller 160 are realized by a processor such as a central processing unit (CPU) or a graphics-processing unit (GPU) executing a program (software). Some or all of such constitution elements may be realized by hardware (a circuit unit including a circuitry) such as a large-scale integration (LSI), an application-specific integrated circuit (ASIC), or a field-programmable gate array (FPGA), or may be realized by software and hardware in cooperation. The program may be stored in the storage 180 of the automated driving control device 100 in advance. Alternatively, the program may be stored in a detachable storage medium such as a DVD or a CD-ROM and may be installed in the storage 180 by attachment of the storage medium to a drive device. The storage 180 is realized by, for example, a HDD, a flash memory, an electrically erasable programmable read-only memory (EEPROM), a read-only memory (ROM), a random-access memory (RAM), or the like. The storage 180 stores, for example, offset amount determination information 182 for determining an offset distance that will be described later as well as a program read and executed by the processor. FIG. 2 is a functional constitution diagram of the first controller 120 and the second controller 160. For example, the first controller 120 includes a recognizer 130 and an action plan generator 140. For example, the first controller 120 realizes a function of artificial intelligence (AI) and a function of a previously given model in parallel. For example, a function of “recognizing an intersection” is executed in parallel with recognition of an intersection by deep learning or the like and recognition based on a previously given condition (there is a pattern-matching signal, a road sign, or the like) and may be realized by giving scores to both sides and comprehensively evaluating the scores. Therefore, reliability of automated driving is guaranteed.

The recognizer 130 recognizes an object that is present in the vicinity of the subject vehicle M on the basis of the information input from the camera 10, the radar device 12, and the finder 14 through the object recognition device 16. The object recognized by the recognizer 130 includes, for example, a bicycle, an auto-bike, a four-wheeled vehicle, a pedestrian, a road sign, a road mark, a lane marking, a utility pole, a guardrail, a falling object, and the like. The recognizer 130 recognizes a state of the object, such as a position, a speed, an acceleration, or the like. For example, the position of the object is recognized as a position on an absolute coordinate (that is, a relative position with respect to the subject vehicle M) using a representative point (center of gravity, driving axis center, or the like) of the subject vehicle M as an origin and is used for control. The position of the object may be represented by a representative point such as a center of gravity or a corner of the object, or may be represented by an expressed region. The “state” of the object may include an acceleration or jerk of the object, or “behavioral state” (for example, the object changes a lane or whether or not the object is about to change the lane).

For example, the recognizer 130 recognizes a subject lane in which the subject vehicle M is traveling and an adjacent lane that is adjacent to the subject lane. For example, the recognizer 130 recognizes the subject lane or the adjacent lane by comparing a pattern of a road lane marking (for example, an arrangement of a solid line and a broken line) obtained from the second map information 62 with a pattern of a road lane marking near the subject vehicle M recognized from the image captured by the camera 10.

The recognizer 130 may recognize the subject lane or the adjacent lane by recognizing a traveling road boundary (a road boundary) including a road lane marking, a road shoulder, a curb, a median strip, a guardrail, and the like, and is not limited to recognizing road lane markings. In this recognition, the position of the subject vehicle M acquired from the navigation device 50 or a process result by an INS may be added. The recognizer 130 recognizes a temporary stop line, an obstacle, a red light, a toll gate, and other road events.

When recognizing the subject lane, the recognizer 130 recognizes the relative position and a posture of the subject vehicle M with respect to the subject lane. For example, the recognizer 130 may recognize an angle formed by a deviation of a reference point of the subject vehicle M from a center of the lane and a line connecting the center of the lane of a traveling direction of the subject vehicle M as a relative position and the posture of the subject vehicle M with respect to the subject lane. Instead of this, the recognizer 130 may recognize a position of the reference point of the subject vehicle M with respect to one of side end portions (the road lane marking or the road boundary) of the subject lane as the relative position of the subject vehicle M with respect to the subject lane.

The recognizer 130 may further recognize a type of the lane on the basis of the recognized road mark, the road sign, a width of the recognized lane, or the like. For example, in a case where the recognizer 130 recognizes a road mark indicating a bicycle mark within the recognized adjacent lane, recognizes a road sign indicating a two-wheeled vehicle dedicated lane above and beside the adjacent lane, or recognizes that a road surface of the adjacent lane is colored with a predetermined color (for example, ash cherry color, brown color, blue color, or the like), the recognition recognizes the adjacent lane as a two-wheeled vehicle dedicated lane.

For example, the two-wheeled vehicle dedicated lane is a lane that is partitioned exclusively for a two-wheeled vehicle such as a bicycle, such as a bicycle dedicated traffic band or a bicycle traveling guidance band, and in principle, the two-wheeled vehicle dedicated lane is not physically partitioned by a structure such as a fence or a pole at a boundary with a roadway from the roadway, and the two-wheeled vehicle dedicated lane is a lane partitioned from the roadway by a lane marking drawn on the road surface.

For example, in a case where a width of the adjacent lane is within a specified range (for example, about 0.5 [m] to 1.5 [m]), the recognizer 130 may recognize the adjacent lane as the two-wheeled vehicle dedicated lane.

The recognizer 130 may recognize that the adjacent lane is the two-wheeled vehicle dedicated lane on the basis of various kinds of information such as the type of the lane and the width of the lane included in the second map information 62.

The action plan generator 140 includes, for example, an event determiner 142 and a target trajectory generator 144. The event determiner 142 determines an automated driving event on a route on which a recommended lane is determined. The event is information that prescribes a traveling mode of the subject vehicle M.

The event includes, for example, a constant-speed traveling event in which the subject vehicle M is caused to travel on the same lane at a constant speed, a follow-up traveling event in which the subject vehicle M is caused to follow the other nearby vehicle (hereinafter, referred to as a preceding vehicle) that is present within a predetermined distance (for example, within 100 [m]) in front of the subject vehicle M, a lane change event in which the subject vehicle M is caused to change the lane from the subject lane to the adjacent lane, a branch event in which the subject vehicle M is caused to branch to a target lane at a branch point of a road, a confluence event in which the subject vehicle M is caused to join to a main line at a confluence point, a takeover event for ending the automated driving and switching to the manual driving, and the like. For example, the “follow-up traveling” may be a traveling mode in which an inter-vehicle distance (relative distance) between the subject vehicle M and the preceding vehicle is kept constant, or may be a traveling mode in which the inter-vehicle distance between the subject vehicle M and the preceding vehicle is kept constant and the subject vehicle M is caused to travel at a center of the subject lane. For example, the event may include an overtaking event in which the subject vehicle M is caused to change the lane to the adjacent lane, overtake the preceding vehicle in the adjacent lane, and change the lane to an original lane again, or in which the subject vehicle M is caused to be close to a lane marking defining the subject lane without changing to the adjacent lane, overtake the preceding vehicle within the same lane, and return the subject vehicle M to an original position (for example, a lane center), and an avoidance event in which the subject vehicle M is caused to perform at least one of braking and steering so as to avoid an obstacle that is present in front of the subject vehicle M, and the like.

For example, the event determiner 142 may change an event that has already been determined for a current section to another event in accordance with a surrounding situation recognized by the recognizer 130 when the subject vehicle M is traveling, or may determine a new event for the current section.

In principle, the target trajectory generator 144 generates a future target trajectory that causes the subject vehicle M to travel automatically (without depending on the operation of the driver) in the traveling mode prescribed by the event, in order to cope with the surrounding situation when the subject vehicle M travels on the recommended lane determined by the recommended lane determiner 61 and the subject vehicle M further travels on the recommended lane. The target trajectory includes, for example, a position element that defines a future position of the subject vehicle M, and a speed element that defines a future speed of the subject vehicle M, and the like.

For example, the target trajectory generator 144 determines a plurality of points (trajectory points) to which the subject vehicle M should sequentially reach as the position element of the target trajectory. The trajectory point is a point to which the subject vehicle M should reach for each predetermined traveling distance (for example, about several [m]). The predetermined traveling distance may be calculated, for example, by a road distance when traveling along the route.

The target trajectory generator 144 determines a target speed and a target acceleration for each predetermined sampling time (for example, about 0 comma [sec]) as the speed element of the target trajectory. The trajectory point may be a position to which the subject vehicle M should reach at a sampling time for each predetermined sampling time. In this case, the target speed and the target acceleration are determined by the sampling time and an interval between the trajectory points. The target trajectory generator 144 outputs information indicating the generated target trajectory to the second controller 160.

The target trajectory generator 144 may change the target trajectory according to the type of the adjacent lane recognized by the recognizer 130. For example, in a case where the adjacent lane is recognized as the two-wheeled vehicle dedicated lane by the recognizer 130, the target trajectory generator 144 generates a target trajectory of which one or both of the speed element and the position element are changed as a new target trajectory corresponding to the current event.

The second controller 160 controls the traveling driving force output device 200, the brake device 210, and the steering device 220 so that the subject vehicle M passes through the target trajectory generated by the target trajectory generator 144 at a scheduled time.

For example, the second controller 160 includes an acquirer 162, a speed controller 164, and a steering controller 166. A combination of the event determiner 142, the target trajectory generator 144, and the second controller 160 is an example of a “driving controller”.

The acquirer 162 acquires information on the target trajectory (a trajectory point) generated by the target trajectory generator 144 and stores the information on the target trajectory in a memory of the storage 180.

The speed controller 164 controls one or both of the traveling driving force output device 200 and the brake device 210 on the basis of the speed element (for example, target speed, target acceleration, or the like) included in the target trajectory that is stored in the memory.

The steering controller 166 controls the steering device 220 according to the position element (for example, curvature representing a degree of curvature of the target trajectory) included in the target trajectory that is stored in the memory. Hereinafter, control of one or both of the traveling driving force output device 200, the brake device 210, and the steering device 220 will be referred to as “automated driving”.

For example, a process of the speed controller 164 and the steering controller 166 is realized by a combination of feed-forward control and feedback control. As an example, the steering controller 166 is executed by a combination of feed-forward control according to a curvature of the road ahead of the subject vehicle M and feedback control based on the deviation from the target trajectory.

The traveling driving force output device 200 outputs, to driving wheels, traveling driving force (torque) for enabling the vehicle to travel. For example, the traveling driving force output device 200 includes a combination of an internal combustion engine, an electric motor, a transmission, and the like, and a power electronic controller (ECU) that controls the internal combustion engine, the electric motor, the transmission, and the like. The power ECU controls the above-described constitutions according to the information input from the second controller 160 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the second controller 160 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. The brake device 210 is not limited to the constitution described above, and may be an electronic control method oil pressure brake device that controls an actuator according to the information input from the second controller 160 to transfer the oil pressure of the master cylinder to the cylinder.

For example, the steering device 220 includes a steering ECU and an electric motor. For example, the electric motor changes a direction of steerable wheels by applying a force to a rack and pinion mechanism. The steering ECU changes the direction of the steerable wheels by driving the electric motor according to the information input from the second controller 160 or the information input from the driving operation element 80.

[Process Flow]

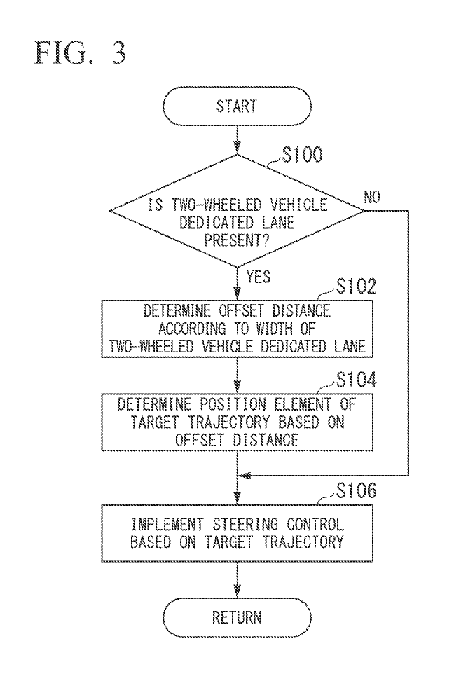

Hereinafter, a flow of a series of processes by the automated driving control device 100 of the first embodiment will be described with reference to a flowchart. FIG. 3 is a flowchart showing an example of a flow of a series of processes by the automated driving control device 100 according to the first embodiment. For example, the process of the present flowchart may be repeatedly executed at a predetermined period in a case where the subject lane and the adjacent lane are recognized by the recognizer 130.

First, for example, the recognizer 130 determines whether or not the recognized adjacent lane is the two-wheeled vehicle dedicated lane, on the basis of the recognized information such as the road mark in the adjacent lane, the road sign near the adjacent lane, and the width of the adjacent lane, the color of the road surface of the adjacent lane, or various kinds of information such as the type or the lane or the width of the lane included in the second map information 62 (step S100).

In a case where it is determined that the adjacent lane is the two-wheeled vehicle dedicated lane by the recognizer 130, the target trajectory generator 144 determines an offset distance ΔY_{OFFSET} for biasing a center position of the subject lane to a side of another adjacent lane that is not a side of the two-wheeled vehicle dedicated lane, on the basis of the width of the two-wheeled vehicle dedicated lane and the offset amount determination information 182 stored in the storage 180 (step S102). A method of determining the offset distance ΔY_{OFFSET} will be described later.

Next, the target trajectory generator 144 determines the position element of the target trajectory on the basis of the determined offset distance ΔY_{OFFSET} (step S104).

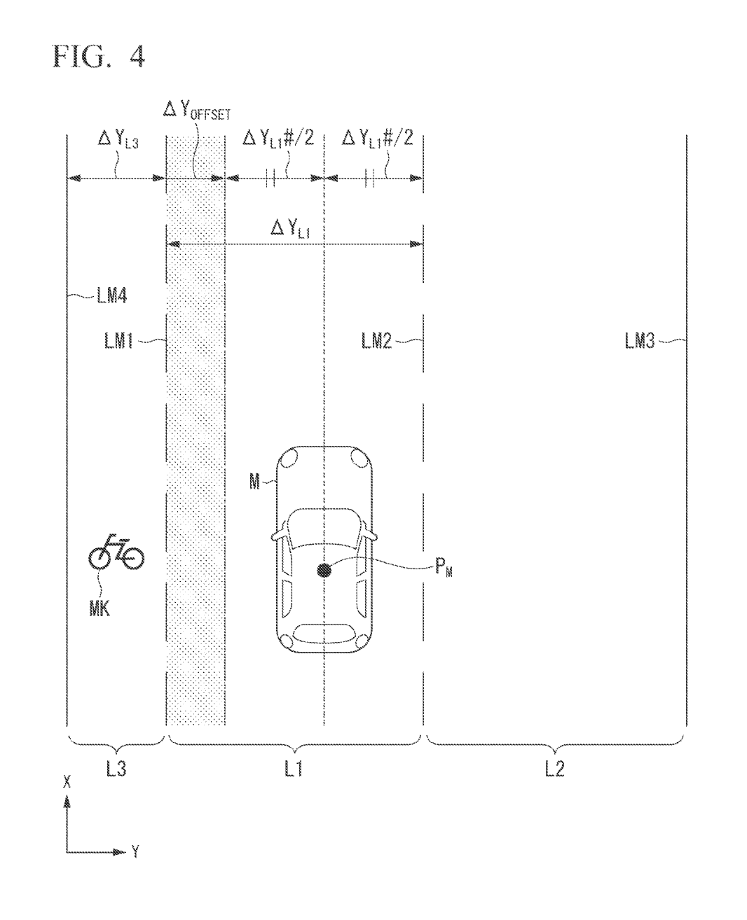

FIG. 4 is a diagram showing an example of a scene in which the subject vehicle M is automatically driven in a case where the two-wheeled vehicle dedicated lane is adjacent to the subject lane. In the figure, X represents the traveling direction of the vehicle (an extending direction of the road), and Y represents a direction orthogonal to the X direction in the vehicle width direction. In the figure, LM1 to LM4 represent the lane markings. A region between the two lane markings LM1 and LM2 nearest to the subject vehicle M among the lane markings LM1 to LM4 is recognized as a subject lane L1, a region between the lane markings LM2 and LM3 is recognized as one adjacent lane L2, and a region between the lane markings LM1 and LM4 is recognized as the other adjacent lane L3. A road mark MK representing a mark of the bicycle is formed on the adjacent lane L3.

In this case, since the road mark MK representing the mark of the bicycle is formed on the adjacent lane L3, the recognizer 130 determines that the recognized adjacent lane L3 is the two-wheeled vehicle dedicated lane. In response to this, the target trajectory generator 144 determines the offset distance ΔY_{OFFSET} according to the width ΔY_{L3} of the two-wheeled vehicle dedicated lane L3.

For example, the target trajectory generator 144 determines a distance for shifting a center of the subject lane L1 on a view to a side of the other lane marking LM2 with reference to the lane marking LM1 on a side of the two-wheeled vehicle dedicated lane L3 of the two lane markings partitioning the subject lane L1, as the offset distance ΔY_{OFFSET}. The target trajectory generator 144 determines a position that is ½ of a remaining distance ΔY_{L1}# (=ΔY_{L1}−ΔY_{OFFSET}) obtained by subtracting the offset distance ΔY_{OFFSET} from a width ΔY_{L1} of the subject lane L1 as a new center of the subject lane L1. In addition, the target trajectory generator 144 determines a trajectory point disposed on the new lane center as the position element of the target trajectory.

Next, the second controller 160 controls the steering device 220 so that a reference point P_{M} (for example, the center of gravity) of the subject vehicle M passes through the target trajectory (a plurality of trajectory points arranged in the X direction), in accordance with the target trajectory generated by the target trajectory generator 144 (step S106). Therefore, for example, in a case where the target trajectory is generated so that a position separated from the center of the original subject lane L1 by the offset distance ΔY_{OFFSET} is set as the new lane center, the subject vehicle M travels on the lane center that is offset from the lane marking LM1 on the side of the two-wheeled vehicle dedicated lane L3.

On the other hand, in the process of S100, in a case where it is determined that the adjacent lane is not the two-wheeled vehicle dedicated lane by the recognizer 130, for example, the target trajectory generator 144 generates the target trajectory including the trajectory point disposed on the center of the original subject lane L1 as the position element, in a case where the current event is a constant-speed traveling event or a follow-up event. That is, the target trajectory generator 144 generates the target trajectory with the offset distance ΔY_{OFFSET} as zero. In a case where such a trajectory is generated, the second controller 160 causes the subject vehicle M to travel at a position that is ½ of ΔY_{L1}. Therefore, the process of the flowchart is ended.

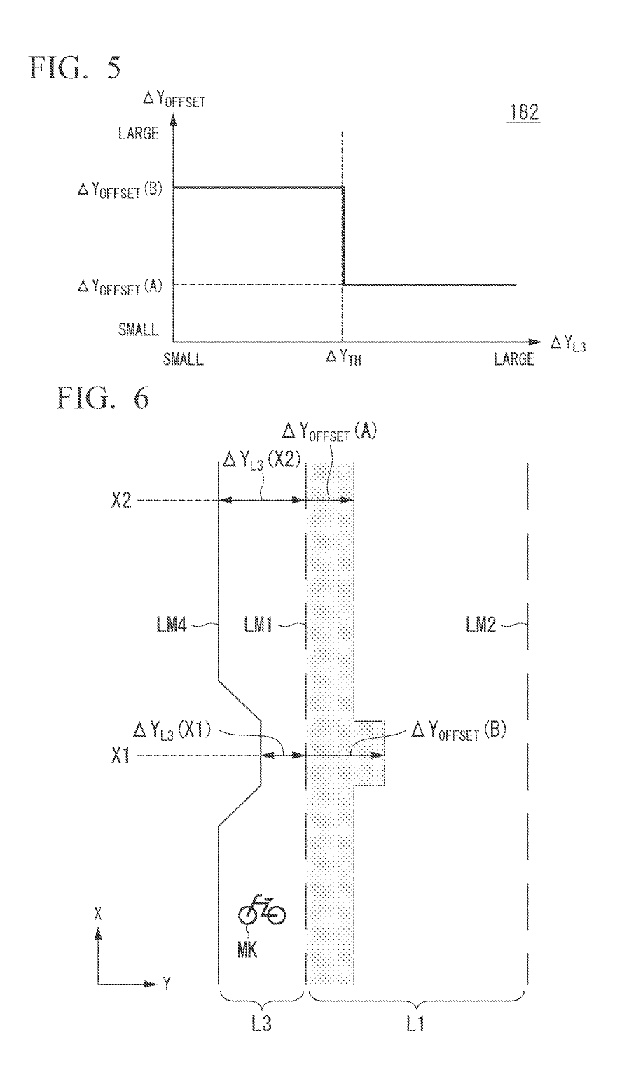

FIG. 5 is a diagram showing an example of the offset amount determination information 182. For example, the offset amount determination information 182 is information in which a magnitude of the offset distance ΔY_{OFFSET} is associated with a magnitude of the width ΔY_{L3} of the two-wheeled vehicle dedicated lane L3. For example, in the width ΔY_{L3} greater than a certain threshold value ΔY_{TH}, a first offset distance ΔY_{OFFSET} (A) is associated with the width ΔY_{L3} thereof, and in the width ΔY_{L3} equal to or less than the threshold value ΔY_{TH}, a second offset distance ΔY_{OFFSET}(B) larger than the first offset distance ΔY_{OFFSET}(A) is associated with the width ΔY_{L3} thereof. Therefore, in a case where the width ΔY_{L3} of the two-wheeled vehicle dedicated lane L3 is greater than the threshold value ΔY_{TH}, the offset distance ΔY_{OFFSET} is determined as the first offset distance ΔY_{OFFSET}(A) that is relatively small, and in a case where the width ΔY_{L3} of the two-wheeled vehicle dedicated lane L3 is equal to or less than the threshold value ΔY_{TH}, the offset distance ΔY_{OFFSET} is determined as the second offset distance ΔY_{OFFSET}(B) larger than the first offset distance ΔY_{OFFSET}(A).

FIG. 6 is a diagram showing an example of the offset distance ΔY_{OFFSET} determined according to the width ΔY_{L3} of the two-wheeled vehicle dedicated lane L3. In the shown example, regarding the X direction, at a point of X1, the width of the two-wheeled vehicle dedicated lane L3 is ΔY_{L3}(X1), and at a point of X2, the width of the two-wheeled vehicle dedicated lane L3 is ΔY_{L3}(X2). It is assumed that the width ΔY_{L3}(X1) is smaller than the width ΔY_{L3}(X2) (ΔY_{L3}(X1)<ΔY_{L3}(X2)) and is equal to or less than the threshold value ΔY_{TH} (ΔY_{L3}(X1)≤ΔY_{TH}). In this case, the target trajectory generator 144 determines the offset distance ΔY_{OFFSET} as the second offset distance ΔY_{OFFSET}(B) in a section where the width of the two-wheeled vehicle dedicated lane L3 is ΔY_{L3}(X1), and determines the offset distance ΔY_{OFFSET} as the first offset distance ΔY_{OFFSET}(A) in a section where the width of the two-wheeled vehicle dedicated lane L3 is ΔY_{L3}(X2), on the basis of offset amount determination information 182. Therefore, in consideration of a high probability that a two-wheeled vehicle protrudes to the side of the subject lane L1 in a section where the width ΔY_{L3} of the two-wheeled vehicle dedicated lane L3 becomes narrower, it is possible to cause the subject vehicle M to move far away from the two-wheeled vehicle dedicated lane L3 in comparison with a section where the width ΔY_{L3} of the two-wheeled vehicle dedicated lane L3 is wide.

In the above-described example, the target trajectory generator 144 sets the offset distance ΔY_{OFFSET} to one of the two values of the first offset distance ΔY_{OFFSET}(A) and the second offset distance ΔY_{OFFSET}(B) with reference to the threshold value ΔY_{TH}, but the present invention is not limited thereto. For example, the target trajectory generator 144 may increase the offset distance ΔY_{OFFSET} as the width ΔY_{L3} of the two-wheeled vehicle dedicated lane L3 becomes narrow, and may reduce the offset distance ΔY_{OFFSET} as the width ΔY_{L3} of the two-wheeled vehicle dedicated lane L3 becomes wide.

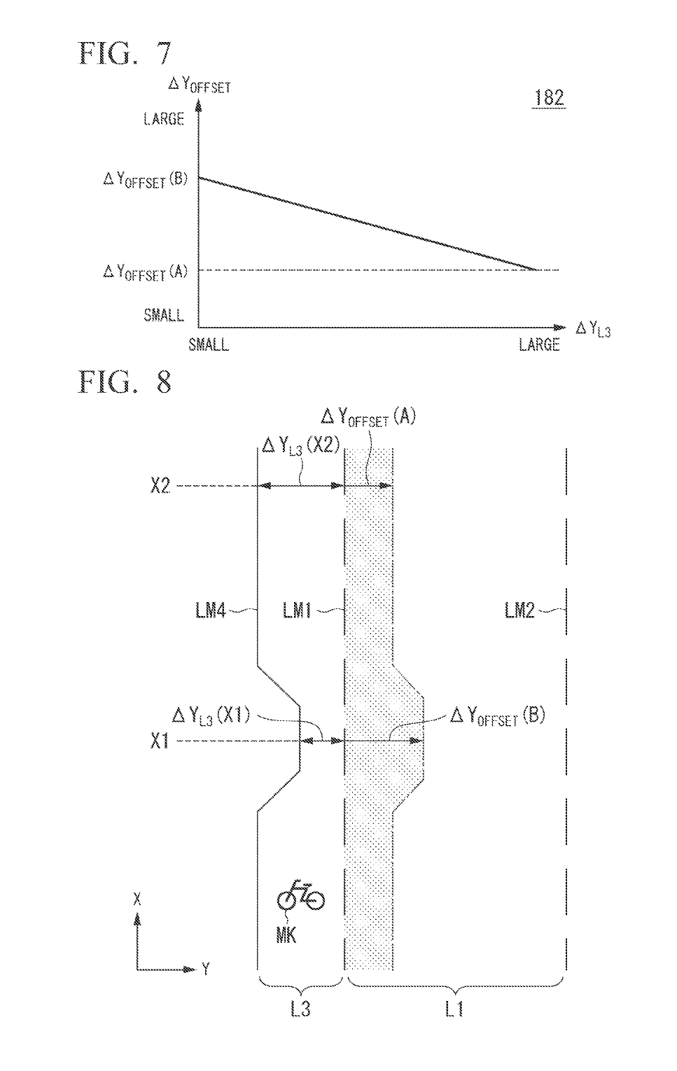

FIG. 7 is a diagram showing another example of the offset amount determination information 182. For example, the offset amount determination information 182 may be information in which a smaller offset distance ΔY_{OFFSET} is associated as the width ΔY_{L3} of the two-wheeled vehicle dedicated lane L3 becomes wide, while an upper limit of the offset distance ΔY_{OFFSET} is the second offset distance ΔY_{OFFSET}(B) and a lower limit of the offset distance ΔY_{OFFSET} is the first offset distance ΔY_{OFFSET}(A). In the shown example, the offset distance ΔY_{OFFSET} linearly changes according to an increase or decrease of the width ΔY_{L3} of the two-wheeled vehicle dedicated lane L3, but the present invention is not limited thereto, and the offset distance ΔY_{OFFSET} may change in a non-linear manner, such as a quadratic function or an exponential function.

FIG. 8 is a diagram showing another example of the offset distance ΔY_{OFFSET} determined according to the width ΔY_{L3} of the two-wheeled vehicle dedicated lane L3. For example, in a case where the offset amount determination information 182 illustrated in FIG. 7 is applied, in a section where the width of the two-wheeled vehicle dedicated lane L3 is contracted from ΔY_{L3}(X2) to ΔY_{L3}(X1), the target trajectory generator 144 may increase the offset distance ΔY_{OFFSET} linearly or non-linearly according to the contraction tendency of the width. Therefore, it is possible to cause the subject vehicle M to move far away from the two-wheeled vehicle dedicated lane L3 more smoothly, while taking into consideration that it is easy for the two-wheeled vehicle to protrude to the side of the subject lane L1 in a section where the width ΔY_{L3} of the two-wheeled vehicle dedicated lane L3 becomes narrower.

In the above description, in a case where the width of the two-wheeled vehicle dedicated lane narrows, the offset distance ΔY_{OFFSET} is increased, but the present invention is not limited thereto, and in a case where the two-wheeled vehicle is recognized on the two-wheeled vehicle dedicated lane by the recognizer 130, the offset distance ΔY_{OFFSET} may be further increased in comparison with a case where the two-wheeled vehicle is not recognized.

According to the first embodiment described above, the recognizer 130 that recognizes the two-wheeled vehicle dedicated lane that is present adjacent to the subject lane on which the subject vehicle M is present, the target trajectory generator 144 that generates the target trajectory for causing the subject vehicle M to move far away from the two-wheeled vehicle dedicated lane in the subject lane, in a case where the two-wheeled vehicle dedicated lane is recognized by the recognizer 130, in comparison with a case where the two-wheeled vehicle dedicated lane is not recognized by the recognizer 130, and the second controller 160 that controls at least the steering device 220 on the basis of the targeted trajectory generated by the target trajectory generator 144 are provided. Therefore, it is possible to perform automated driving sufficiently far away from the two-wheeled vehicle of another lane (adjacent lane).

### Second Embodiment

Hereinafter, a second embodiment will be described. The second embodiment is different from the above-described first embodiment in that, in a case where the adjacent lane that is adjacent to the subject lane is the two-wheeled vehicle dedicated lane, at a point where it is easy for the two-wheeled vehicle to enter the two-wheeled vehicle dedicated lane from the outside of the road, the subject vehicle M is caused to move far away from the two-wheeled vehicle dedicated lane in comparison with at other points. For example, the point where it is easy for the two-wheeled vehicle to enter the two-wheeled vehicle dedicated lane from the outside of the road is a point where the two-wheeled vehicle dedicated lane appears next to the subject lane (hereinafter, referred to as a start point). Hereinafter, differences from the first embodiment will be mainly described, and descriptions of functions and the like that are the same as in the first embodiment will be omitted.

For example, the recognizer 130 according to the second embodiment recognizes that the start point of the two-wheeled vehicle dedicated lane is present in front of the subject vehicle M, on the basis of a recognition result such as the number of lane markings, an angle formed by the lane markings, and a ratio of the width of the lane to the width of the entire road. The recognizer 130 may recognize that the start point of the two-wheeled vehicle dedicated lane is present in front of the subject vehicle M, on the basis of the information (for example, the number of lanes) included in the second map information 62.

In a case where it is recognized that the start point of the two-wheeled vehicle dedicated lane is present in front of the subject vehicle M by the recognizer 130, the target trajectory generator 144 according to the second embodiment increases the offset distance ΔY_{OFFSET} at the start point of the two-wheeled vehicle dedicated lane in comparison with a case where the subject vehicle M is present behind the start point of the two-wheeled vehicle dedicated lane at the start point of the two-wheeled vehicle dedicated lane.

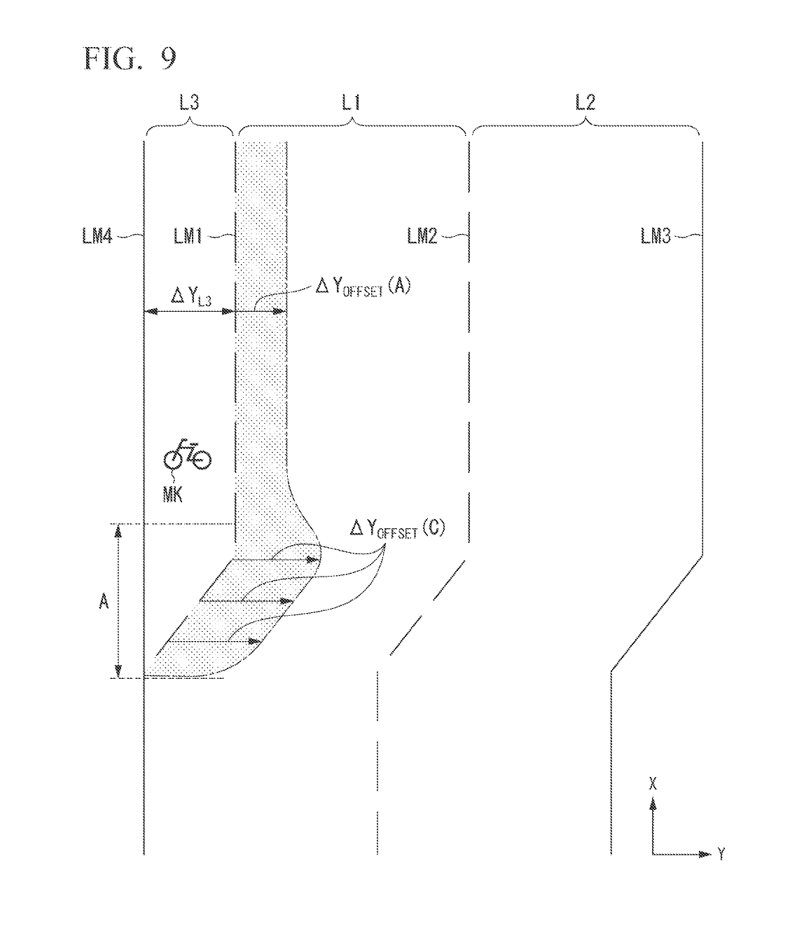

FIG. 9 is a diagram showing an example of a scene in which the start point of the two-wheeled vehicle dedicated lane is present. In the figure, A represents the start point of the two-wheeled vehicle dedicated lane. In such a case, the recognizer 130 recognizes that the start point A of the two-wheeled vehicle dedicated lane is present in front of the subject vehicle M. In response to this, the target trajectory generator 144 determines the offset distance ΔY_{OFFSET} at the start point A of the two-wheeled vehicle dedicated lane as a third offset distance ΔY_{OFFSET}(C) larger than the first offset distance ΔY_{OFFSET}(A). For example, the third offset distance ΔY_{OFFSET}(C) may be larger than or equal to the second offset distance ΔY_{OFFSET}(B). Therefore, it is possible to cause the subject vehicle M to move far away from the two-wheeled vehicle dedicated lane at the start point of the two-wheeled vehicle dedicated lane, in comparison with other points (points after A in the figure) where it is not recognized that the start point of the two-wheeled vehicle dedicated lane is present in front of the subject vehicle M.

In the above description, it is assumed that the point where it is easy for the two-wheeled vehicle to enter the two-wheeled vehicle dedicated lane from the outside of the road is the start point of the two-wheeled vehicle dedicated lane, but the present invention is not limited thereto. For example, the point where it is easy for the two-wheeled vehicle to enter the two-wheeled vehicle dedicated lane from the outside of the road may be a boundary of the road where a structure (hereinafter, referred to as a road boundary structure ST1) extending along the extending direction X of the road is broken. The road boundary structure ST1 is, for example, a curb stone or the like. The point where the road boundary structure ST1 is broken is an example of a “structure separation point”.

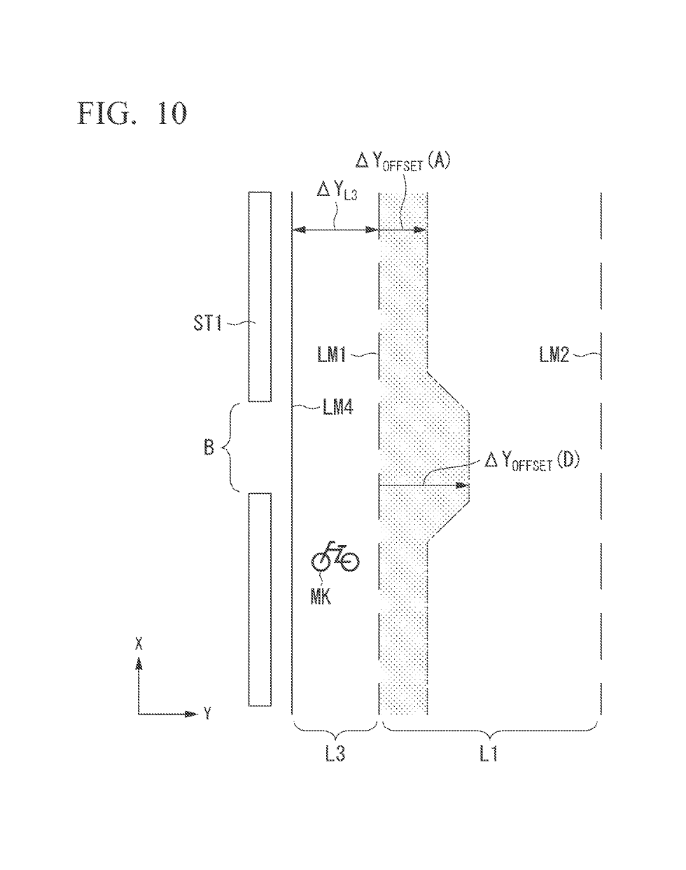

FIG. 10 is a diagram showing an example of a scene in which a point where the road boundary structure ST1 is broken is present. In the figure, B represents a point where the road boundary structure ST1 is broken. In such a case, the recognizer 130 recognizes that the point B where the road boundary structure ST1 is broken is present in front of the subject vehicle M. In response to this, the target trajectory generator 144 determines the offset distance ΔY_{OFFSET} at the point B where the road boundary structure ST1 is broken as a fourth offset distance ΔY_{OFFSET}(D) larger than the first offset distance ΔY_{OFFSET}(A). For example, the fourth offset distance ΔY_{OFFSET}(D) may be larger than the second offset distance ΔY_{OFFSET}(B) or the third offset distance ΔY_{OFFSET}(C), or may be equal to one or both of such offset distances. Therefore, it is possible to cause the subject vehicle M to move far away from the two-wheeled vehicle dedicated lane at the point where the road boundary structure ST1 is broken is present in front of the subject vehicle M, in comparison with other points where it is not recognized that the point where the road boundary structure ST1 is broken is present in front of the subject vehicle M.

According to the second embodiment described above, it is possible to perform automated driving away from the two-wheeled vehicle dedicated lane after assuming that the two-wheeled vehicle is traveling on the two-wheeled vehicle dedicated lane, in order to increase the offset distance ΔY_{OFFSET} at the point where it is easy for the two-wheeled vehicle to enter the two-wheeled vehicle dedicated lane from the outside of the road, in comparison with the other points. For example, at a point where the two-wheeled vehicle enters the two-wheeled vehicle dedicated lane from a shoulder or the like, since a traveling direction of the two-wheeled vehicle and an extending direction of the two-wheeled vehicle dedicated lane are not parallel, even though the two-wheeled vehicle dedicated lane is partitioned off, there may be a case where the two-wheeled vehicle having excess momentum enters the subject vehicle lane. In this case, there is a case where the two-wheeled vehicle and the subject vehicle M may be too close to each other. On the other hand, in the second embodiment, since the subject vehicle M is caused to move far away from the two-wheeled vehicle dedicated lane at the point where the two-wheeled vehicle enters the two-wheeled vehicle dedicated lane, it is possible to perform automated driving in a state in which the subject vehicle M is sufficiently far away from the two-wheeled vehicle.

### Third Embodiment

Hereinafter, a third embodiment will be described. The third embodiment is different from the first and second embodiments described above in that in a case where a structure such as a fence or a pole (hereinafter, referred to as a lane separation structure ST2) is present at a boundary between the two-wheeled vehicle dedicated lane and the subject lane, and the two-wheeled vehicle dedicated lane and the subject lane are physically partitioned, the subject vehicle M is caused to be closer to the two-wheeled vehicle dedicated lane, in comparison with a case where the two-wheeled vehicle dedicated lane and the subject lane are not physically partitioned by the lane separation structure ST2. Hereinafter, differences from the first and second embodiments will be mainly described, and descriptions of functions and the like the same as in the first and second embodiments will be omitted.

The recognizer 130 in the third embodiment recognizes the lane separation structure ST2 that is present between the two-wheeled vehicle dedicated lane and the subject lane as an object that is present in the vicinity of the subject vehicle M. In a case where the lane separation structure ST2 that is present between the two-wheeled vehicle dedicated lane and the subject lane is recognized by the recognizer 130, the target trajectory generator 144 in the third embodiment sets the offset distance ΔY_{OFFSET} to be smaller in comparison with a case where the lane separation structure ST2 is not recognized, since a probability that the two-wheeled vehicle traveling on the two-wheeled dedicated lane protrudes to the side of the subject lane is lowered.

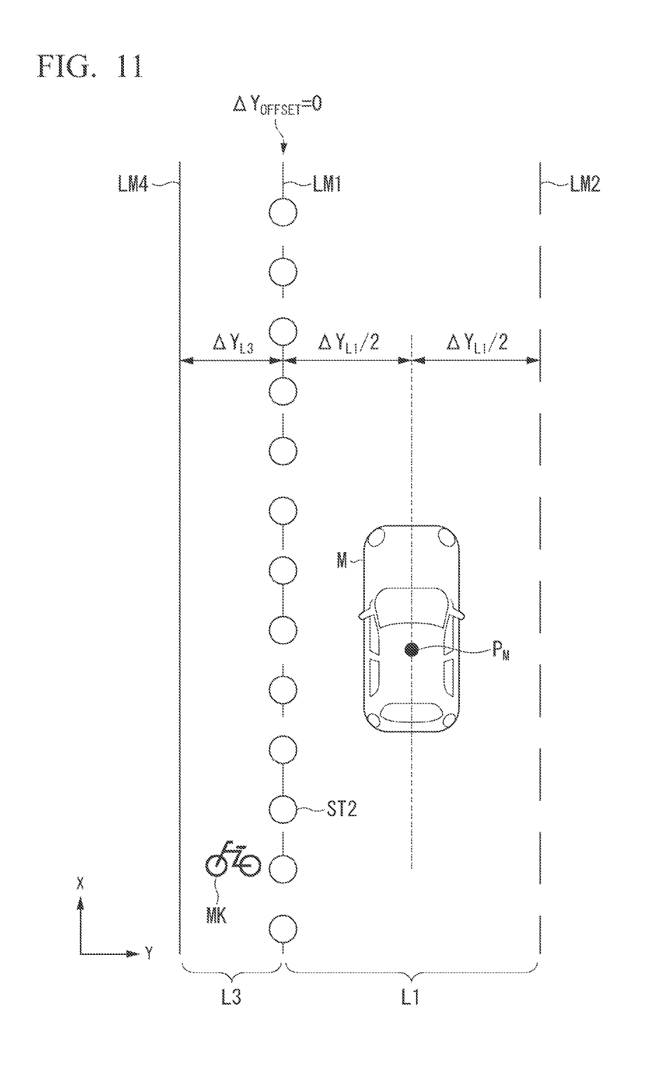

FIG. 11 is a diagram showing an example of a scene in which the lane separation structure ST2 is present. In a case of the shown example, since the lane separation structure ST2 that is present between the two-wheeled vehicle dedicated lane L3 and the subject lane L1 is recognized by the recognizer 130, the target trajectory generator 144 generates, for example, the offset distance ΔY_{OFFSET} to zero to generate the target trajectory. That is, the target trajectory generator 144 generates a target trajectory including a trajectory point disposed on the center of the original subject lane L1 as the position element. As a result, the second controller 160 causes the subject vehicle M to travel with the position of ½ of the width ΔY_{L1} of the subject lane L1 as the center of the lane.

According to the third embodiment described above, in a case where the lane separation structure ST2 is present between the two-wheeled vehicle dedicated lane and the subject lane, since the offset distance ΔY_{OFFSET} is smaller in comparison with a case where the lane separation structure ST2 is not present, it is possible to suppress unnecessary steering control.

### Fourth Embodiment

Hereinafter, a fourth embodiment will be described. In the first to third embodiments described above, as the width of the two-wheeled vehicle dedicated lane becomes narrower, the offset distance ΔY_{OFFSET} is larger, in the point where it is easy for the two-wheeled vehicle to enter the two-wheeled vehicle dedicated lane, in comparison with the other points, the offset distance ΔY_{OFFSET} is larger, or in a case where the lane separation structure ST2 is present between the two-wheeled vehicle dedicated lane and the subject lane, the offset distance ΔY_{OFFSET} is smaller in comparison with the case where the lane separation structure ST2 is not present. On the other hand, the fourth embodiment is different from the first to third embodiments described above in that the speed of the subject vehicle M is changed, in a case where the above-described various conditions are satisfied, in addition to or instead of changing the offset distance ΔY_{OFFSET}. Hereinafter, differences from the first to third embodiments will be mainly described, and descriptions of the functions and the like the same as in the first to third embodiments will be omitted.

For example, in a case where it is recognized that the adjacent lane is the two-wheeled vehicle dedicated lane by the recognizer 130, the target trajectory generator 144 according to the fourth embodiment determines the speed element of the target trajectory, on the basis of speed determination information 184 in which the width of the two-wheeled vehicle dedicated lane is associated with the target speed to be output by the subject vehicle M and the like. For example, it is assumed that the speed determination information 184 is stored in the storage 180 in advance.

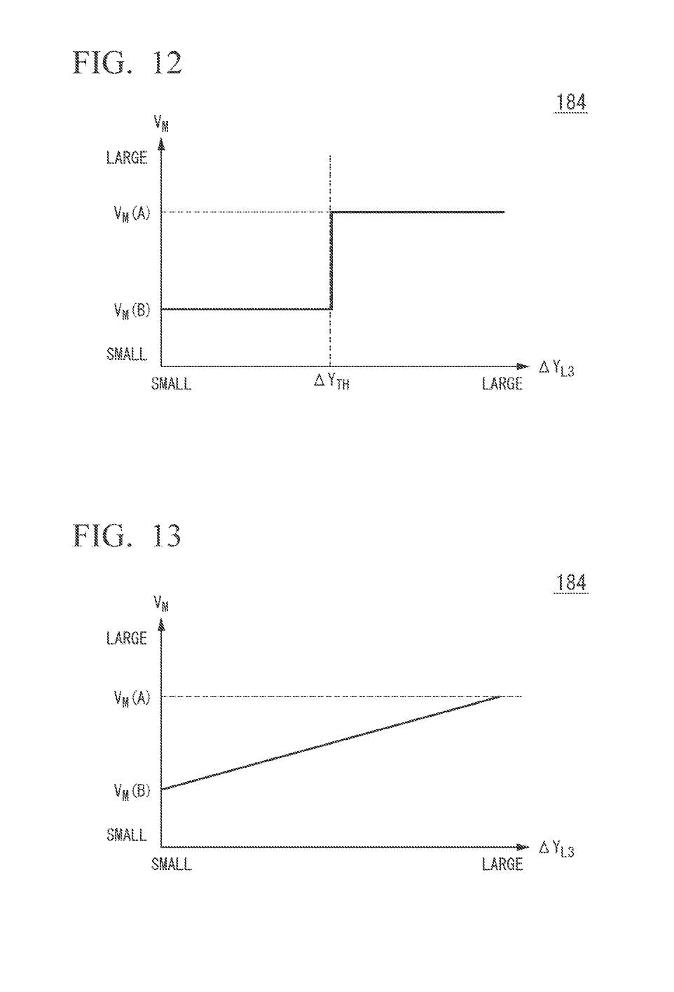

FIG. 12 is a diagram showing an example of the speed determination information 184. For example, the speed determination information 184 is information in which a target speed V_{M} to be output by the subject vehicle M is associated with the width ΔY_{L3} of the two-wheeled vehicle dedicated lane L3. For example, a first speed V_{M}(A) is associated with a width ΔY_{L3} that is a width ΔY_{L3} greater than a threshold value ΔY_{TH}, and a second speed V_{M}(B) less than the first speed V_{M}(A) is associated with a width ΔY_{L3} that is a width ΔY_{L3} equal to or less than the threshold value ΔY_{TH}. Therefore, in a case where the width ΔY_{L3} of the two-wheeled vehicle dedicated lane L3 is greater than the threshold value ΔY_{TH}, the target speed V_{M} of the subject vehicle M is determined as the relatively large first speed V_{M}(A), and in a case where the width ΔY_{L3} of the two-wheeled vehicle dedicated lane L3 is equal to or less than the threshold value ΔY_{H}), the target speed V_{M} of the subject vehicle M is determined as the second speed V_{M}(B) less than the first speed V_{M}(A). Thus, in a case where the width ΔY_{L3} of the two-wheeled vehicle dedicated lane L3 is equal to or less than the threshold value ΔY_{TH}, the target trajectory generator 144 generates a target trajectory including the target speed V_{M} as the speed element less in comparison with a case where the width ΔY_{L3} of the two-wheeled vehicle dedicated lane L3 is greater than the threshold value ΔY_{TH}. In the example described above, the target trajectory generator 144 determines the speed V_{M} of the subject vehicle M as one of two values of the first speed V_{M}(A) and the second speed V_{M}(B) based on the threshold value ΔY_{TH}, but the present invention is not limited thereto. For example, the target trajectory generator 144 is able to reduce the target speed V_{M} of the subject vehicle M as the width ΔY_{L3} of the two-wheeled vehicle dedicated lane L3 becomes narrower, and the target trajectory generator 144 is able to increase the target speed V_{M} of the subject vehicle M as the width ΔY_{L3} of the two-wheeled vehicle dedicated lane L3 is widened.

FIG. 13 is a diagram showing another example of the speed determination information 184. For example, the speed determination information 184 may be information in which a smaller target speed V_{M} is associated with the width ΔY_{L3} of the two-wheeled vehicle dedicated lane L3 as the width ΔY_{L3} of the two-wheeled vehicle dedicated lane L3 becomes narrower, in a state in which an upper limit of the target speed V_{M} of the subject vehicle M is the first speed V_{M}(A) and a lower limit of the target speed V_{M} of the subject vehicle M is the second speed V_{M}(B). In the shown example, the target speed V_{M} is linearly changed according to the increase or decrease of the width ΔY_{L3} of the two-wheeled vehicle dedicated lane L3, but the present invention is not limited thereto, and the target speed V_{M} may be changed in a non-linear manner such as a quadratic function or an exponential function. The speed determination information 184 is not limited to the information in which the target speed V_{M} is associated with the width ΔY_{L3} of the two-wheeled vehicle dedicated lane L3, but a target acceleration, a target jerk, a rate of change in speed, and the like may be associated with the width ΔY_{L3} of the two-wheeled vehicle dedicated lane L3.

As in the second embodiment, in a case where it is recognized that a point where it is easy for the two-wheeled vehicle to enter is present in front of the subject vehicle M in the two-wheeled vehicle dedicated lane, such as the start point of the two-wheeled vehicle dedicated lane or a point where the road boundary structure ST1 is broken, by the recognizer 130, the target trajectory generator 144 according to the fourth embodiment may generate a target trajectory including a smaller target speed V_{M} as the speed element in comparison with a case where such an event is not recognized.

As in the third embodiment, in a case where it is recognized that the lane separation structure ST2 is present between the two-wheeled vehicle dedicated lane and the subject lane by the recognizer 130, the target trajectory generator 144 according to the fourth embodiment may generate a target trajectory including a smaller target speed V_{M} as the speed element in comparison with a case where it is not recognized that the lane separation structure ST2 is present between the two-wheeled vehicle dedicated lane and the subject lane.

According to the fourth embodiment described above, in a case where the width of the two-wheeled vehicle dedicated lane is equal to or less than the threshold value ΔY_{TH}, or in a case where there is a point where it is easy for the two-wheeled vehicle to enter within the two-wheeled vehicle dedicated lane, in addition to or instead of changing the offset distance ΔY_{OFFSET}, in order to change the speed of the subject vehicle M, the subject vehicle M is able to overtake the two-wheeled vehicle on the subject lane, in a state in which the subject vehicle M is caused to be sufficiently far away from the two-wheeled vehicle of the adjacent lane and the speed of the subject vehicle M is sufficiently reduced, in a case where the lane separation structure ST2 is present between the two-wheeled vehicle dedicated lane and the subject lane, or the like.

[Hardware Constitution]

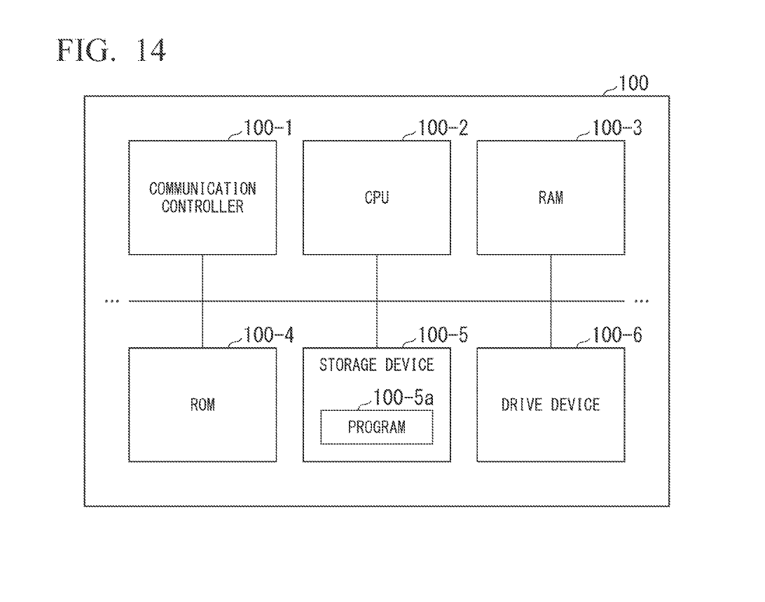

FIG. 14 is a diagram showing an example of a hardware constitution of the automated driving control device 100 according to an embodiment. As shown in the figure, the automated driving control device 100 includes a constitution in which a communication controller 100-1, a CPU 100-2, a RAM 100-3 used as a working memory, a ROM 100-4 storing a boot program and the like, a storage device 100-5 such as a flash memory or a HDD, a drive device 100-6 and the like are mutually connected by an internal bus or a dedicated communication line. The communication controller 100-1 communicates with components other than the automated driving control device 100. A program 100-5a executed by the CPU 100-2 is stored in the storage device 100-5. This program is developed in the RAM 100-3 by a direct memory access (DMA) controller (not shown) or the like and executed by the CPU 100-2. Therefore, a part or all of the first controller 120 and the second controller 160 are realized.

The above-described embodiment is able to be expressed as follows.

A vehicle control device, including:

a storage that stores a program; and

a processor,

wherein the processor executes the program to:

recognize a two-wheeled vehicle dedicated lane that is present adjacent to a subject lane on which a subject vehicle is present; and

control at least steering of the subject vehicle to cause the subject vehicle to move far away from the two-wheeled vehicle dedicated lane in the subject lane in comparison with a case where the two-wheeled vehicle dedicated lane is not recognized, in a case where the two-wheeled vehicle dedicated lane is recognized.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device, comprising:
a recognizer configured to recognize a two-wheeled vehicle dedicated lane that is present adjacent to a subject lane on which a subject vehicle is present; and
a driving controller configured to control at least steering of the subject vehicle and cause the subject vehicle to move far away from the two-wheeled vehicle dedicated lane in the subject lane in comparison with a case where the two-wheeled vehicle dedicated lane is not recognized by the recognizer, in a case where the two-wheeled vehicle dedicated lane is recognized by the recognizer.

2. The vehicle control device of claim 1,
wherein the driving controller determines a degree to which the subject vehicle is caused to move far away from the two-wheeled vehicle dedicated lane in the subject lane, on the basis of a width of the two-wheeled vehicle dedicated lane.

3. The vehicle control device of claim 1,
wherein the driving controller causes the subject vehicle to move far away from the two-wheeled vehicle dedicated lane in the subject lane as a width of the two-wheeled vehicle dedicated lane becomes narrower.

4. The vehicle control device of claim 1,
wherein, in a case where a width of the two-wheeled vehicle dedicated lane is equal to or less than a threshold value, the driving controller causes the subject vehicle to move far away from the two-wheeled vehicle dedicated lane in the subject lane in comparison with a case where the width of the two-wheeled vehicle dedicated lane is greater than the threshold value.

5. The vehicle control device of claim 1,
wherein the recognizer further recognizes a start point of the two-wheeled vehicle dedicated lane, and
in a case where the start point recognized by the recognizer is present in front of the subject vehicle, the driving controller causes the subject vehicle to move far away from the two-wheeled vehicle dedicated lane in the subject lane in comparison with a case where the subject vehicle is present at a position behind the start point, at the start point.

6. The vehicle control device of claim 1,
wherein the recognizer further recognizes a structure separation point where a structure extending along a road is broken, which is a structure that represents a boundary of the road including the subject lane and the two-wheeled vehicle dedicated lane, and
in a case where the structure separation point recognized by the recognizer is present in front of the subject vehicle, the driving controller causes the subject vehicle to move far away from the two-wheeled vehicle dedicated lane in the subject lane in comparison with a case where the structure separation point is not present in front of the subject vehicle, at the structure separation point.

7. The vehicle control device of claim 1,
wherein the recognizer further recognizes a structure that is present between the subject lane and the two-wheeled vehicle dedicated lane, and
in a case where the structure that is present between the subject lane and the two-wheeled vehicle dedicated lane is recognized by the recognizer, the driving controller causes the subject vehicle to be not away from the two-wheeled vehicle dedicated lane in the subject lane in comparison with a case where the structure that is present between the subject lane and the two-wheeled vehicle dedicated lane is not recognized by the recognizer.

8. The vehicle control device of claim 1,
wherein, in the case where the two-wheeled vehicle dedicated lane is recognized by the recognizer, the driving controller further controls a speed of the subject vehicle so that the speed of the subject vehicle is reduced in comparison with the case where the two-wheeled vehicle dedicated lane is not recognized by the recognizer.

9. The vehicle control device of claim 8,
wherein the driving controller determines a degree of the reduction in the speed of the subject vehicle on the basis of a width of the two-wheeled vehicle dedicated lane.

10. The vehicle control device of claim 8,
wherein the driving controller causes the speed of the subject vehicle to be less as a width of the two-wheeled vehicle dedicated lane becomes narrower.

11. The vehicle control device of claim 8,
wherein, in a case where a width of the two-wheeled vehicle dedicated lane is equal to or less than a threshold value, the driving controller reduces the speed of the subject vehicle in comparison with a case where the width of the two-wheeled vehicle dedicated lane is greater than the threshold value.

12. The vehicle control device of claim 8,
wherein the recognizer further recognizes a start point of the two-wheeled vehicle dedicated lane, and
in a case where the start point recognized by the recognizer is present in front of the subject vehicle, the driving controller reduces the speed of the subject vehicle in comparison with a case where the subject vehicle is present at a position behind the start point, at the start point.

13. The vehicle control device of claim 8,
wherein the recognizer further recognizes a structure separation point where a structure extending along a road is broken, which is a structure that represents a boundary of the road including the subject lane and the two-wheeled vehicle dedicated lane, and
in a case where the structure separation point recognized by the recognizer is present in front of the subject vehicle, the driving controller reduces the speed of the subject vehicle in comparison with a case where the structure separation point is not present in front of the subject vehicle, at the structure separation point.

14. The vehicle control device of claim 8,
wherein the recognizer further recognizes a structure that is present between the subject lane and the two-wheeled vehicle dedicated lane, and
in a case where the structure that is present between the subject lane and the two-wheeled vehicle dedicated lane is recognized by the recognizer, the driving controller does not reduce the speed of the subject vehicle in comparison with a case where the structure that is present between the subject lane and the two-wheeled vehicle dedicated lane is not recognized by the recognizer.

15. A vehicle control method that causes an in-vehicle computer to:
recognize a two-wheeled vehicle dedicated lane that is present adjacent to a subject lane on which a subject vehicle is present; and
control at least steering of the subject vehicle to cause the subject vehicle to move far away from the two-wheeled vehicle dedicated lane in the subject lane in comparison with a case where the two-wheeled vehicle dedicated lane is not recognized, in a case where the two-wheeled vehicle dedicated lane is recognized.

16. A computer-readable non-transitory storage medium storing a program that causes an in-vehicle computer to execute:
a process of recognizing a two-wheeled vehicle dedicated lane that is present adjacent to a subject lane on which a subject vehicle is present; and
a process of controlling at least steering of the subject vehicle to cause the subject vehicle to move far away from the two-wheeled vehicle dedicated lane in the subject lane in comparison with a case where the two-wheeled vehicle dedicated lane is not recognized, in a case where the two-wheeled vehicle dedicated lane is recognized.
